(19) United States
(12) Patent Application Publication
(10) Pub. No.: US 2012/0278509 A1
(43) Pub. Date: Nov. 1, 2012

(54) UPDATING DEVICE AND METHOD THROUGH A BASEBOARD MANAGEMENT CONTROLLER THEREOF

(75) Inventors: WAN-HONG ZHANG, Shenzhen City (CN); LE LIN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/167,720

(22) Filed: Jun. 24, 2011

(30) Foreign Application Priority Data
Apr. 28, 2011 (CN) 201110107303.X

(51) Int. Cl. G06F 3/00

(52) U.S. Cl. 710/8

(57) ABSTRACT

An updating device connected to a network adapter card ROM, the updating device includes a baseboard management controller. The baseboard management controller is electrically connected to the network adapter card ROM. The baseboard management controller stores an update data for the network adapter card ROM. When the baseboard management controller starts, the baseboard management controller writes the update data into the network adapter card ROM. A method of updating a network adapter card ROM is also provided.

### BACKGROUND

1. Technical Field

The present disclosure relates to an updating device.

2. Description of Related Art

Software of an electrically erasable programmable read-only memory (EEPROM) of a network adapter card can be updated by a manufacturer of the EEPROM. Updating the software of the EEPROM requires a computer with an operating system. However, assembling the computer and setting up the operating system just for updating the EEPROM is not expedient and will waste a lot of time.

What is needed, therefore, is system and method capable of avoiding or overcoming the described limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a block diagram of an updating device according to an exemplary embodiment.

FIG. 2 is a flowchart of a method of updating a network adapter card ROM according to an exemplary embodiment.

### DETAILED DESCRIPTION

Embodiments of the present disclosure are described in detail as follows, with reference to the accompanying drawings.

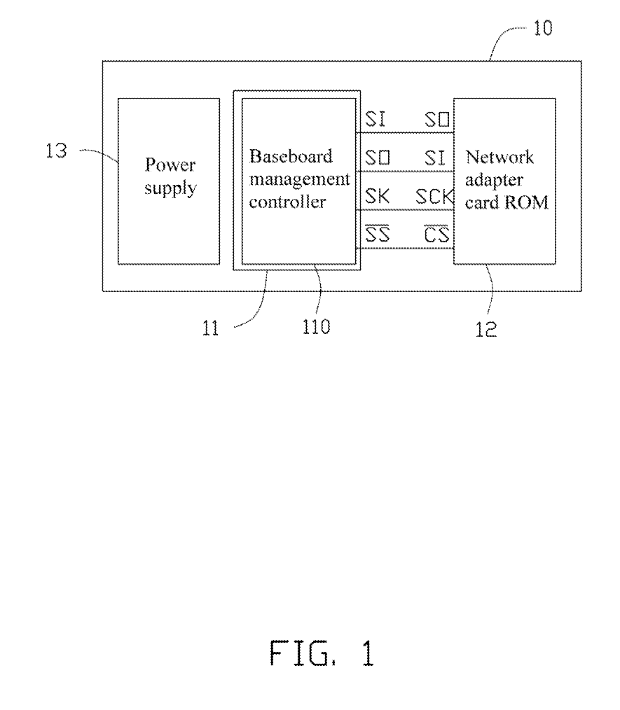

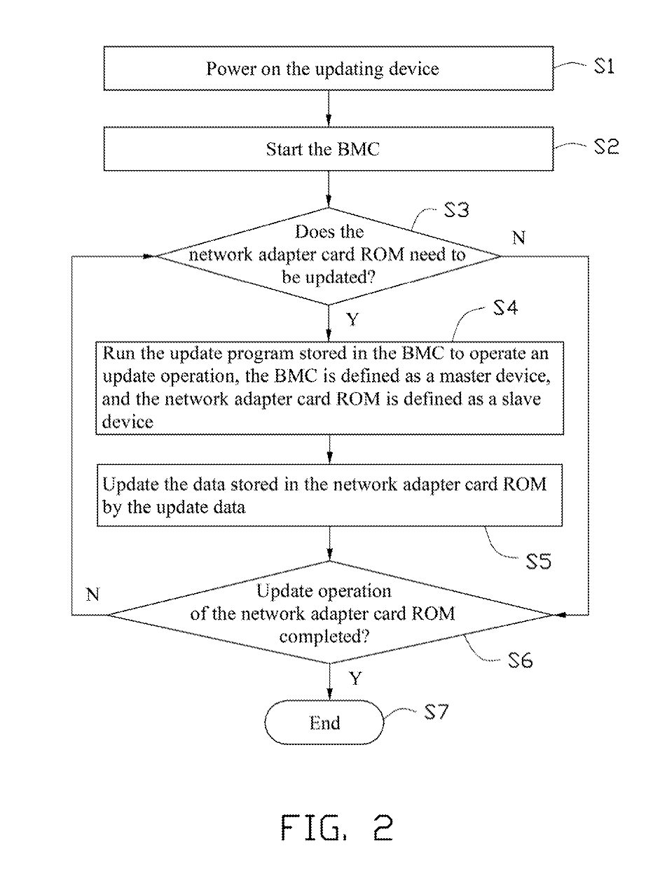

Referring to FIGS. 1 and 2, a computer 10 according to an embodiment is shown. The computer 10 includes an updating device 11, a network adapter card ROM 12, and a power supply 13.

The network adapter card ROM 12 and the power supply 13 are both electrically connected to the updating device 11. The network adapter card ROM 12 is an EEPROM. The power supply 13 powers the computer 10. When the power supply 13 is electrically connected to an external power supply (not shown), the power supply 13 powers the updating device 11 and the network adapter card ROM 12. The updating device 11 updates data/software of the network adapter card ROM 12 including about a network adapter card type information, manufacture names, and driving programs. The updating device 11 includes a baseboard management controller (BMC) 110.

The BMC 110 stores updated data for the network adapter card ROM 12, an identification information corresponding to the update data, and an update program for the network adapter card ROM 12. The identification information marks/tags the updated data. When the BMC 110 receives an update command, the BMC 110 captures the identity information of the network adapter card ROM 13 by applying a preset identifying mechanism. The update command can be preset in the computer 10 by users.

The BMC 110 is a controller that provides intelligent management of an intelligent platform management, and has an independent operating system. If the power supply 13 is taken directly from the external power supply, the BMC 110 runs without booting the operation system of the computer 10, and the updating device 11 can function effectively even if the power supply 13 of the computer 10 does not boot up the operating system of the computer 10.

In the present embodiment, the BMC 110 is a microchip. The BMC 110 communicates with a peripheral device by a serial peripheral interface (SPI) bus. The SPI bus includes a data input line SI, a data output line SO, a slave select line S̅S̅, and a clock line SCLK.

The data input line SI, the data output line SO, the slave select line S̅S̅, and the clock line SCLK are respectively and electrically connected to an SI terminal, an SO terminal, an S̅S̅ terminal, and an SCLK terminal of the network adapter card ROM 12.

The manner of updating the network adapter card ROM 12 is the same as for the updating of the BIOS is in a DOS-based operating system. The slave select line S̅S̅ is at a low level voltage. The low level voltage is 0. The network adapter card ROM 12 is defined as a slave device. The BMC 110 is defined as a master device. The BMC 110 sends an SCLK signal to the network adapter card ROM 12 to update the network adapter card ROM 12. The BMC 110 and the network adapter card ROM 12 communicate with each other by the a data input line SI, a data output line SO, an SI terminal, and an SO terminal. When the update program is finished, the slave select line S̅S̅ goes to a high level voltage, and the communication between the BMC 110 and the network adapter card ROM 12 is cut off. The high level voltage is 1. At this time, the update operation of the network adapter card is complete. The capacities and updating functions of the BMC 110 allow it to operate independently of the computer operating system, the BMC 110 and the network adapter card ROM 12 can communicate with each other without starting the computer 10.

Referring to FIG. 3, an updating method of the network adapter card includes the following steps.

In step S1, power on the updating device 11. The power supply 13 directly powers the updating device 11.

In step S2, start BMC 110. When the updating device 11 is powered by the power supply 13, the BMC 110 begins to function automatically.

In step S3, does the network adapter card ROM 12 needs to be updated? The BMC 110 determines whether the update operation need to be operated or not by the update command preset in the computer 10 by users. If the network adapter card ROM 12 does not need to be updated, then the BMC 110 performs step S7. If the network adapter card ROM 12 does need to be updated, then the BMC 110 performs step S4.

In step S4, run the update program stored in the BMC 110 to operate an update operation, the BMC 110 is defined as a master device, and the network adapter card ROM 12 is defined as a slave device. In the present embodiment, the slave select line S̅S̅ of the BMC 110 is at low level voltage. The low level voltage is 1. The BMC 110 is defined as a master device. The network adapter card ROM 12 is defined as a slave device. The BMC 110 controls the network adapter card ROM 12 to updates data.

In step S5, update the data stored in the network adapter card ROM 12 by the update data. Data stored in the network adapter card ROM 12 is updated by the update data stored in the BMC 110.

In step S6, update operation of the network adapter card ROM 12 completed? In the present embodiment, the BMC 110 monitors the data stored in the network adapter card ROM 12. When the slave select line S̅S̅ is at high level voltage, then the BMC 110 performs step S7, otherwise the BMC 110 performs step S4. The high level voltage is 1.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

1. An updating device for use in a computer and connected to a network adapter card ROM of the computer, the computer comprising an operating system which is run after the computer is booted up, the updating device comprising:
a baseboard management controller electrically connected to the network adapter card ROM, the baseboard management controller storing an update data for the network adapter card ROM;
wherein when the baseboard management controller starts, the baseboard management controller writes the update data into the network adapter card ROM without booting up the computer and running the operating system.

2. The updating device as claimed in claim 1, wherein the baseboard management controller is electrically connected to the network adapter card ROM by a serial peripheral interface (SPI) bus.

3. The updating device as claimed in claim 2, wherein the SPI bus comprises a data input line, a data output line, a slave select line, and a clock line, and they are electrically connected to an SI terminal, an SO terminal, an S̅S̅ terminal, and an SCLK terminal of the network adapter card ROM respectively.

4. The updating device as claimed in claim 1, wherein the network adapter card ROM is an electrically erasable programmable read-only memory.

5. A method of updating a network adapter card ROM of a computer, the computer comprising an operating system which is run after the computer is booted up, the method comprising:
providing an updating device comprising a baseboard management controller to the computer, the baseboard management controller storing an update data and an update program for the network adaptor car ROM;
starting the baseboard management controller without booting up the computer and running the operating system;
determining whether the network adapter card ROM needs to be updated;
running the update program to operate an update operation, defining the baseboard management controller as a master device, defining the network adapter card ROM as a slave device; and
updating the network adapter card ROM by the update data without booting up the computer and running the operating system.

6. (canceled)

7. The method as claimed in claim 5, wherein the baseboard management controller is a controller that provides intelligent management of an intelligent platform management.

8. The method as claimed in claim 5, wherein the baseboard management controller comprises an independent operating system with respect to the operating system.

9. The method as claimed in claim 5, wherein the baseboard management controller is a microchip.
